(19) United States
(12) Patent Application Publication
(10) Pub. No.: US 2006/0140252 A1
(43) Pub. Date: Jun. 29, 2006

(54) Apparatus and related method for data transmission across a wireless network

(76) Inventor: Richard M Miller, Lingfield (GB)

Correspondence Address: PHILIPS INTELLECTUAL PROPERTY & STANDARDS, P.O. BOX 3001, BRIARCLIFF MANOR, NY, 10510, US

(21) Appl. No.: 10/526,193

(22) PCT Filed: Aug. 22, 2003
(86) PCT No.: PCT/IB03/03782

§ 371 Date: Sep. 29, 2005

(30) Foreign Application Priority Data
Sep. 5, 2002 (GB) 0220618.3

(51) Int. Cl. H04B 1/69

(52) U.S. Cl. 375/138

(57) ABSTRACT

The present invention provides for a transmitting means for transmitting data packets in a wireless network, wherein at least some of the data packets are arranged to include clock data for use at a receiving means in the network for clock reconstruction at the receiving means, the transmitting means including processing means and operating system means connected to a network controller for delivering the data packets to the network, wherein the transmitting means is arranged to identify packets arriving at the network controller and which require clock data, and wherein the network controller is arranged to insert the clock data within the said identified packet prior to transmission of the packet. Also provided is a system and method of synchronising the clock of a receiving means to a clock signal from a transmitting means in a wireless network, wherein the clock at the receiving means is reconstructed from a data packet delivered from the transmitting means and including the step of monitoring acknowledgement of receipt of the packet at the receiving means, and resending the said packet if receipt is not acknowledged, and including the step of inserting updated clock reference data in the packet prior to resending the packet.

The present invention relates to a method and related apparatus for the transmission of data across a wireless network and in particular, but not exclusively, to a method and apparatus for streaming real-time audio and video content across a wireless network link.

Communication systems are being developed which seek to stream real-time audio and video data across standardised wireless network links. However it has been identified that problems arise relating to the synchronisation of the audio/video data content at a client terminal when seeking to output and display the content at exactly the same rate as it was originally produced.

While systems employing standard set-top boxes can readily employ a synchronisation clock taken directly from the incoming transport stream, a client terminal that is connected to a server merely by way of a standardised wireless network does not have accurate access to this clock. The incoming transport stream arriving at such set-top boxes comprises a highly stable signal produced by a broadcaster for a client/server wireless network infrastructure, accurate access to this clock cannot be achieved due to jitter inherent in the wireless network and also due to latency arising within the networking software of the system. As such, high-level software is arranged to insert a clock reference into a packet to be sent through the network, a highly variable delay between when the clock reference is inserted and when the packet is sent, and when the software at the client device will actually retrieve the clock reference in the packet will be experienced.

Published patent application US 2002/0031196 discloses a clock-regeneration system in which a server is arranged to transmit a small packet at regular intervals, and which seeks to describe clock data for subsequent use in achieving synchronisation at a client device. However, the manner in which the containing the clock data packets are created and sent is disadvantageously limited, and the system itself also has disadvantages particularly if packet-delivery failure occurs.

The present invention seeks to provide for an apparatus and related method which can be used for the accurate synchronisation of, for example, audio and video data transmitted from a server across a standard wireless network link to one or more client devices.

According to one aspect of the present invention there is provided transmitting means for transmitting data packets in a wireless network, wherein at least some of the data packets are arranged to include clock data for use at a receiving means in the network for clock reconstruction at the receiving means, the transmitting means including processing means and operating system means connected to a network controller for delivering the data packets to the network, wherein the transmitting means is arranged to identify packets arriving at the network controller and which require clock data, and wherein the network controller is arranged to insert the clock data within the said identified packet prior to transmission of the packet.

The invention is advantageous in that through the adaptation of the wireless network control in the above-mentioned manner, the clock data held within the packet being transmitted is found to be very close to the running clock in the transmitting means.

The feature of claim 2 is particularly advantageous in allowing for identification of the appropriate clock signal to be inserted within the packet and in particular with regard to the intended receiving means.

The subject matter of claim 3 renders the invention particularly advantageous if the wireless network protocol requires, for any particular reason, a packet to be resent.

The features of claim 4 serve to make advantageous use of the appearance of previous clock reference within a packet if a resend is required.

The features of claims 5, 6 and 7 offer particularly advantageous, but simplified, means for identifying that a packet to be sent over the network is to include clock reference data.

The features of claims 8, 9 and 10 prove advantageous for situations in which the transmitting means might be required to transmit different streams of data to the respective different receiving means, each of which might require clock references running at slightly different rates.

According to another aspect of the present invention, there is provided receiving means for receiving signals delivered over a wireless network and which include packets with clock reference data from a transmitting means for reconstruction of a clock reference at the receiving means, the receiving means including a front end comprising a wireless network controller connected to operating system means, wherein the said front end is arranged to identify clock reference data in a packet and to synchronise a clock of the receiving means accordingly.

The features of claims 12 and 13 are advantageous in allowing reconstruction of the clock in a manner so as to minimise errors arising therein.

Advantageously, and as defined in claim 14, the operating system of the receiving means can be arranged to identify data entering a particular socket at the receiving means and so as to provide a particular reliable and accurate arrangement for identifying those data packets that also include clock data.

As defined in claims 15 and 16, the clock of the receiving means can advantageously be set directly once identified at either the wireless network controller or the operating system therefore. Alternatively the receiving means can include a feedback arrangement whereby a local clock value and frequency are altered to keep time with the incoming clock data received from transmitting means over the wireless network.

According to a further aspect of the present invention, there is provided a method including the step of synchronising a receiving means to a clock of a transmitting means over a wireless network, the transmitting means including processing means and operating system means for delivering data packets to the network of inserting at the wireless network controller clock reference data into identified packets and prior to delivery of the packets onto the wireless network.

The present invention also provides for a wireless network system of synchronising a receiving means to a clock of a transmitting means over a wireless network, the transmitting means including processing means and operating system means for delivering data packets to the network including the means for identifying data packets in which clock reference data is to be inserted and means for inserting at the wireless network controller clock reference data into the identified packets and prior to delivery of the packets onto the wireless network.

In accordance with another aspect of the present invention, there is provided transmitting means for transmitting data packets in a wireless network, wherein at least some of the data packets are arranged to include clock data for use at receiving means in the network for clock reconstruction at the receiving means, the transmitting means including processing means and operating system means connected to a network controller for delivering the data packets to the network, and including means for determining receipt at the receiving means of the data packets sent over the network and arranged to resend the packet if receipt is not acknowledged, the network controller further being arranged to insert updated clock reference data prior to resending a packet.

Advantageously, the updated clock reference is arranged to be inserted within the data packet in a manner as defined above.

In a further aspect of the present invention, there is provided a method of synchronising the clock of a receiving means to a clock signal from a transmitting means in a wireless network, wherein the clock at the receiving means is reconstructed from a data packet delivered from the transmitting means and including the step of monitoring acknowledgement of receipt of the packet at the receiving means, and resending the said packet if receipt is not acknowledged, and including the step of inserting updated clock reference data in the packet prior to resending the packet.

Advantageously, the step of inserting the updated clock reference data is conducted as defined above.

As should therefore be appreciated, the present invention provides for a method and related system and apparatus for enhancing synchronization between real-time clocks within a wireless network environment particularly if data packets containing clock reference data are to be resent.

The invention is described further hereinafter, by way of example only, with reference to the accompanying drawings in which:

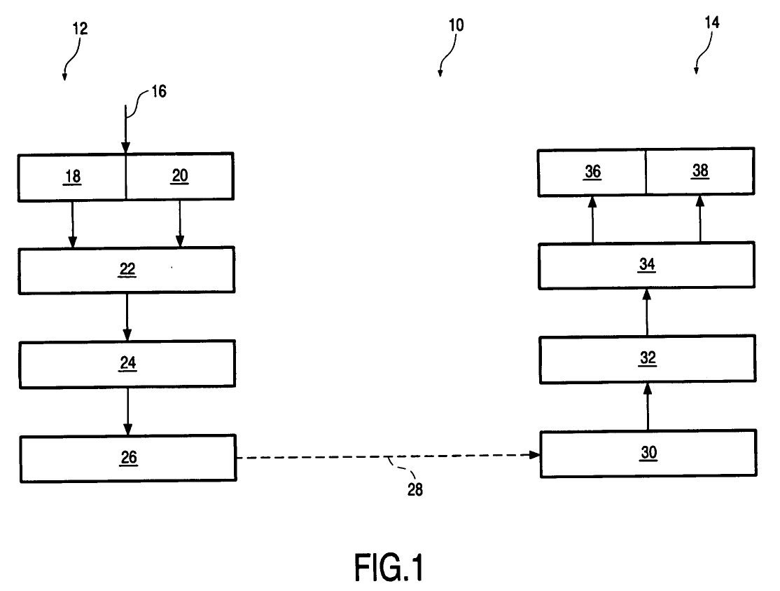

FIG. 1 is a schematic block diagram of a currently known wireless network system illustrating a server and a client; and

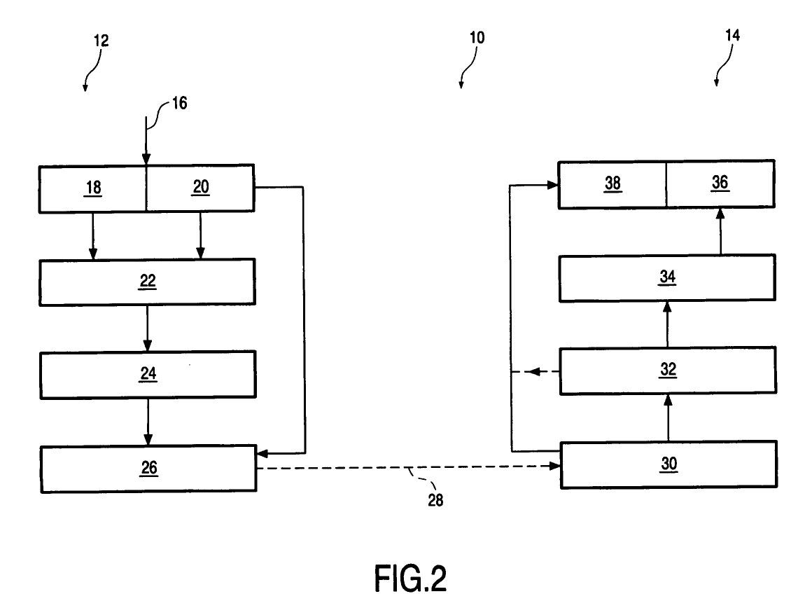

FIG. 2 is a schematic block diagram of a wireless network system employing a server and a client and embodying an aspect of the present invention.

Turning first to FIG. 1, there is illustrated a wireless network communications system 10 arranged for use as part of a wireless network as currently known and comprising a server 12 and client 14.

In order to achieve synchronisation between the server 12 and client 14, the client 14 seeks to reconstruct a clock signal corresponding to that running at the server 12.

A transport stream input signal 16 is delivered to the server 12 to a demultiplexer 18 and clock regeneration element 20 for producing a memory mapped clock by means of which clock reference data is generated from the input transport stream 16.

A processor 22 arranged to run wireless audio/video protocol software is also arranged to receive the clock reference from the clock unit 20 and to insert the reference into an appropriate packet for onward transmission as a so-called clock packet. Thus, the software within the processor 22 is arranged to read the memory mapped clock at the clock unit 20 and to insert this information into a packet, which data is then added to the end of a variable length register such as a FIFO.

The clock packet is delivered from the processor 22 to an operating system 24 which includes an IP networking stack.

A wireless network controller 26 is connected to the operating system 24 by means of, for example of a PCI bus, or PI bus for onward delivery over a wireless network link 28 to the client device 14.

It will be appreciated that there will therefore necessarily be some delay between insertion of the clock reference into the packet at the processor 22, and the eventual delivery of the packet onto the wireless network 28 particularly in view of the variety of queues and registers that are inherent in the connectivity between the processor 22 and indeed the operating system 24 and the wireless network controller 26.

As will be appreciated from the following description of the client 14, similar queues and registers as arising in the server 12 are found within the connectivity inherent in the client 14 and which introduce further latency with regard to the passage of the clock packet before the clock reference is eventually reconstructed.

Turning now to the client 14, it will be appreciated that this corresponds to the server 12, and including a wireless network controller 30, operating system 32, a processor 34 and decoder 36 and a clock regeneration unit 38.

However, insofar as the client 14 is arranged to receive data from the wireless network link 28, it is the wireless network controller 30 that is arranged to receive data for onward deliver through the client device 14 via the operating system 32 and processor 34. A clock generation unit 38 comprises a memory mapped clock system for establishment of a clock signal of variable value and frequency and the decoders 36 are arranged to operate under control of the memory mapped clock.

However, in this known system, the delays in latency discussed above prove disadvantageously limiting in seeking to reproduce the clock from the server 12 at the client 14.

Turning now to FIG. 2, there is illustrated a system arrangement embodying an aspect of the present invention and which includes similar elements at the server and client to those illustrated in FIG. 1. The same reference numerals have been employed where appropriate.

However, the configuration and control of these elements is quite different and leads to the particular advantages inherent in the present invention.

In the configuration of the illustrated embodiment of the present invention in FIG. 2, it will be appreciated that the memory-mapped clock data is not delivered from the clock unit 20 to the processor 22, but rather is delivered directly to the wireless network controller 26. Likewise, at the client device 14, the wireless network controller 30, or alternatively, the operating system 32 is arranged to establish the regenerated clock 36 directly rather than via the processor 34.

Returning to the client device 12, the processor 22 is arranged to deliver instructions to the operating system 24 and the wireless network controller 26 that, in particular, identify the data packets that are to be accompanied by clock reference data.

Upon receipt of such packets at the wireless network controller 26, the controller 26 reads memory-mapped clock data directly from the clock unit 20 and overwrites a particular location within the packet with the clock value. Thus, just before the wireless network controller 26 is about to transmit a packet over the wireless connection 28, and which has been marked by the operating system as a “clock” packet, the wireless controller reads the memory-mapped clock 20 to obtain an up-to-date clock value for delivery over the wireless connection 28. This is true both for the case in which the packet is being sent for the first time or also if the wireless protocol requires the packet to be resent, for example due to failure of delivery of the packet when originally sent. If the packet is being resent, then the clock data is advantageously updated at the wireless network controller prior to resending.

The above-mentioned features allow for the clock reference data held within a clock packet to remain very close to the clock running in the server 12.

It should be appreciated that there are variety of ways in which a particular packet can be marked as a so-called clock packet. One aspect comprises an arrangement in which an application is determined to use a setting on a specific datagram socket and this dictates that all packets passing through that particular socket should therefore be marked as a datagram. Such a setting can also serve to identify where within the packet the wireless network controller 26 should write the clock data. As an alternative, the clock signal could be included within out-of-banned data.

At the client device 14, although reconstruction of the clock could be achieved in a user-level application, it is noted that some jitter would still arise due to the FIFO employed at the client.

As noted in the illustrated embodiment, the clock setting is advantageously therefore achieved by the wireless network controller or by lower levels of the operating system 32. Further, not only is control achieved through the operating system so as to identify which packets are to contain clock data reference, the operating system can also be arranged to set an off-set and length within the packet into which the clock data reference is to be inserted.

The client 14 can be arranged to operate in a manner similar to the server 12 insofar as the wireless network controller 30 or the operating system 32 can be arranged to identify data entering a particular socket in the client system. Such data is therefore readily identified and the client system clock then set to the new value. As illustrated in FIG. 2, the system clock in the client can be set directly although it should be appreciated that the feedback mechanism can be employed wherein a clock's value and frequency and adjusted to keep in time with the identified incoming clock data.

The present invention is particular advantageous in that clock information is included within packets along with the data in, for example, a one to one network. However, the invention could be advantageously employed for use with multi-cast networks and in a situation where a server is streaming different streams to a large number of clients and, in particular, where the streams might require respective clock references running at slightly different rates. In this manner, the packet can also contain a reference describing which real-time clock should be accessed for such packets.

Again, this can prove particularly advantageous in a situation where a server might to required to stream different streams to a variety of clients each of which requires a different clock reference from a respective different clock source.

As noted, the invention also advantageously allows for the updating of clock reference data within signals that are being resent. The appearance of previous, and now out of date, clock reference data within a packet to be resent can advantageously be employed within the wireless network controller as a means for identifying those packets that are to have clock reference data introduced therein prior to transmission over the wireless link.

It should be appreciated that the present invention is not restricted to the details of the foregoing embodiment insofar as it can be employed for use in any appropriate communication system requiring real-time clock synchronisation with wireless network protocols.

1. Transmitting means (12) for transmitting data packets in a wireless network, wherein at least some of the data packets are arranged to include clock data for use at a receiving means (14) in the network for clock reconstruction at the receiving means (14), the transmitting means (12) including processing means (22) and operating system means (24) connected to a network controller (26) for delivering the data packets to the network, wherein the transmitting means (12) is arranged to identify packets arriving at the network controller (26) and which require clock data, and wherein the network controller (26) is arranged to insert the clock data within the said identified packet prior to transmission of the packet.

2. Transmitting means as defined in claim 1 wherein the network controller (26) is arranged to read a memory-mapped clock (20) in order to obtain the clock reference data.

3. Transmitting means as claimed in claim 1 or 2 and arranged to insert clock reference data into packets that are to be resent over the network.

4. Transmitting means as claimed in claim 1, 2 or 3 and arranged to employ a setting on a datagram socket in order to identify a packet for the inclusion of clock reference data.

5. Transmitting means as claimed in claim 4 and arranged such that the setting on the datagram socket further identifies where within the packet the clock reference data is to be inserted.

6. Transmitting means as claimed in any one of claims 1-3 and arranged to deliver the clock signal as out-of-band data.

7. Transmitting means as defined in any one or more of claims 1-6, and arranged such that the clock reference is included within packets along with data to be transmitted over the network.

8. Transmitting means as claimed in any one or more of claims 1-7, and arranged to obtain clock reference data from a plurality of clocks running at different rates.

9. Transmitting means as claimed in claim 8 and arranged to include within a packet a reference identifying which of the plurality of clocks is to be accessed for providing the clock reference data.

10. Transmitting means as claimed in claim 9, wherein the operating system (24) is arranged to set an offset and length within a packet in which the clock reference data is to be inserted.

11. Receiving means (14) for receiving signals delivered over a wireless network and which include packets with clock reference data from a transmitting means (12) for reconstruction of a clock reference at the receiving means (14), the receiving means (14) including a front end comprising a wireless network controller (30) connected to operating system means (32), wherein the said front end (30, 32) is arranged to identify clock reference data in a packet and to synchronise a clock (38) of the receiving means (14) accordingly.

12. Receiving means as claimed in claim 11, wherein the clock is arranged to be set by means of the wireless network controller (30).

13. Receiving means as claimed in claim 11, wherein the clock is arranged to be set by means of the operating system (32).

14. Receiving means as claimed in claim 11, 12 or 13 and arranged to identify data entering a particular socket therein for identification of the clock reference data.

15. Receiving means as claimed in any one or more of claims 11-14, wherein the clock is arranged to be set directly from the reconstructed clock data.

16. Receiving means as claimed in any one or more of claims 11-14, and including feedback means arranged to control alteration of a local clock on the basis of the recovered clock data.

17. A method including the step of synchronising a receiving means (14) to a clock of a transmitting means (12) over a wireless network, the transmitting means (12) including processing means (22) and operating system means (24) for delivering data packets to the network and including the step of inserting, at the wireless network controller (26), clock reference data into identified packets and prior to delivery of the packets onto the wireless network.

18. A system (10) of synchronising a receiving means (14) to a clock of a transmitting means (12) over a wireless network, the transmitting means (12) including processing means (22) and operating system means (24) for delivering data packets to the network, including means for identifying the data packets in which clock reference data is to be inserted and means for inserting, at the wireless network controller (24), clock reference data into the identified packets and prior to delivery of the packets onto the wireless network.

19. Transmitting means (12) for transmitting data packets in a wireless network, wherein at least some of the data packets are arranged to include clock data for use at receiving means (14) in the network for clock reconstruction at the receiving means (14), the transmitting means (12) including processing means (22) and operating system means (24) connected to a network controller for delivering the data packets to the network, and including means for determining receipt at the receiving means (14) of the data packets sent over the network and arranged to resend the packet if receipt is not acknowledged, the network controller (26) further being arranged to insert updated clock reference data prior to resending a packet.

20. Transmitting means as claimed in claim 19 and further comprising a transmitting means as claimed in any one or more of claims 1 to 10.

21. A method of synchronising the clock of a receiving means (14) to a clock signal from a transmitting means (12) in a wireless network, wherein the clock at the receiving means (14) is reconstructed from a data packet delivered from the transmitting means (12) and including the step of monitoring acknowledgement of receipt of the packet at the receiving means (14), and resending the said packet if receipt is not acknowledged, and including the step of inserting updated clock reference data in the packet prior to resending the packet.

22. A method as claimed in claim 21, and further comprising the method as claimed in claim 17.
